(19) United States
(12) Patent Application Publication
(10) Pub. No.: US 2025/0138315 A1
(43) Pub. Date: May 1, 2025

(54) CALIBRATING DISTORTION AND MISALIGNMENT OF DISPLAYS IN FISH TANK STYLE VR

(71) Applicant: Sony Interactive Entertainment Inc., Tokyo (JP)

(72) Inventors: Koichi Obana, San Mateo, CA (US); Yuichiro Nakamura, San Mateo, CA (US); Greg Corson, San Mateo, CA (US); Jeff Stafford, San Mateo, CA (US)

(21) Appl. No.: 18/498,764

(22) Filed: Oct. 31, 2023

(51) Int. Cl. G02B 27/01

(52) U.S. Cl. CPC G02B 27/0172; G02B 2027/011; G02B 2027/0138; G02B 2027/014; G02B 2027/0198

(57) ABSTRACT

Techniques and devices are described for detecting and addressing irregularities in one or more display panels that are used for presenting virtual reality (VR) images. Thus, based on one or more detected irregularities, an electronic system can determine a metric by which to warp an image to account for the display panel irregularities and then use the metric for subsequent rendering of images.

### FIELD

The disclosure below relates to technically inventive, non-routine solutions that are necessarily rooted in computer technology and that produce concrete technical improvements, and more specifically to calibrating distortion and misalignment of displays in single and multi-display assemblies for VR.

### BACKGROUND

As understood herein, so-called “fish tank” display assemblies have been provided. Such assemblies render the image on the display as coupled to the head position of the observer as if he/she looks into a fish tank. One display may be used for this purpose, or plural flat panel displays arranged in a box-shaped configuration may be used. Either way, the display(s) can be controlled to produce images as if seen in a fish tank, with the user able to physically move around at different angles to inspect different areas of the rendered virtual object. However, it is recognized herein that improvements can be made to these systems to make them more immersive.

### SUMMARY

As further understood herein, each display panel that is used for a fish tank-style display assembly may have relatively small but notable irregularities in terms of flatness, orientation, and display presentation ability. These irregularities can negatively affect the overall quality of the virtual image, leading to a rendering that seems off to the user. This in turn adversely affects the overall immersiveness of the virtual reality (VR) presentation itself.

Accordingly, in one aspect an apparatus includes at least one processor assembly that is configured to present first and second dot patterns on different respective display panels of a multi-display panel assembly. The at least one processor assembly is also configured to receive one or more images from a camera, where the one or more images show the first and second dot patterns. Based on the one or more images from the camera, the at least one processor assembly is configured to identify one or more irregular display panel features related to the first display panel and/or the second display panel. Based on the one or more irregular display panel features, the at least one processor assembly is configured to identify and store a metric by which to warp subsequent images that will be presented on the first and second panels.

In some examples, the at least one processor assembly may also be configured to use the metric to present a first image on the first and second panels. Also in some examples, the first and second dot patterns may be different from each other.

In various example implementations, the first and second dot patterns may be presented sequentially, where the first dot pattern may be presented before the second dot pattern. The one or more irregular display panel features may relate to one or more surface contour features of the first display panel and/or the second display panel. Additionally or alternatively, the one or more irregular display panel features may relate to misalignment of the first display panel with the second display panel, as well as brightness, contrast, and/or resolution of the first display panel and/or the second display panel. As another example, the one or more irregular display panel features may additionally or alternatively relate to chromatic dispersion of red, green, and/or blue pixels of a first image presented on at least one of the first and second display panels.

In some specific cases, the apparatus may even include the camera itself.

In another aspect, an apparatus includes at least one computer medium that is not a transitory signal. The at least one computer medium includes instructions executable by at least one processor assembly to present first and second patterns on different portions of a display assembly and to receive one or more images from a camera. The one or more images show the first and second patterns. The instructions are also executable to identify one or more display panel features related to the display assembly based on the one or more images from the camera, and to identify and store a metric by which to alter presentation of subsequent images that will be presented on the display assembly based on the one or more display panel features.

In certain examples, the instructions may also be executable to use the metric to present a first image on the display assembly. Additionally, the first and second patterns may be dot patterns if desired.

In various example implementations, the display panel features may include irregular display panel features. The irregular display panel features themselves may include one or more irregular surface contour features of the display assembly. Additionally or alternatively, the irregular display panel features may include misalignment of a first display panel on the display assembly with respect to a second display panel on the display assembly. As other examples, the irregular display panel features may include irregular brightness of the display assembly, irregular contrast of the display assembly, and/or irregular resolution of the display assembly.

In still another aspect, a method includes presenting at least a first image on a display assembly and receiving one or more second images from a camera. The one or more second images show the first image. The method also includes, based on the one or more second images from the camera, identifying one or more display panel features related to the display assembly. The method then includes rendering a subsequent image on the display assembly according to a metric by which to alter presentation of the subsequent image. The metric itself is determined based on the one or more display panel features.

In certain examples, the method may also include presenting the first image and a third image to identify the one or more display panel features. The first and third images may include respective patterns that are asymmetric from each other.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates an example multi-display assembly consistent with present principles;

FIG. 3 illustrates schematically the pixels of a display consistent with present principles;

FIG. 4 shows an oblique view of a fish tank style VR assembly that is presenting dot patterns, with the dot patterns being useable to identify display panel irregularities consistent with present principles;

FIGS. 5A-5D show additional example dot patterns and other images that may be presented on the assembly for identifying display panel irregularities consistent with present principles;

FIG. 6 shows an example graphical user interface (GUI) that may be presented to begin a display calibration process consistent with present principles;

FIG. 7 shows an example GUI that may be presented responsive to completion of the display calibration process consistent with present principles; and

FIG. 8 illustrates example logic in example flow chart format consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

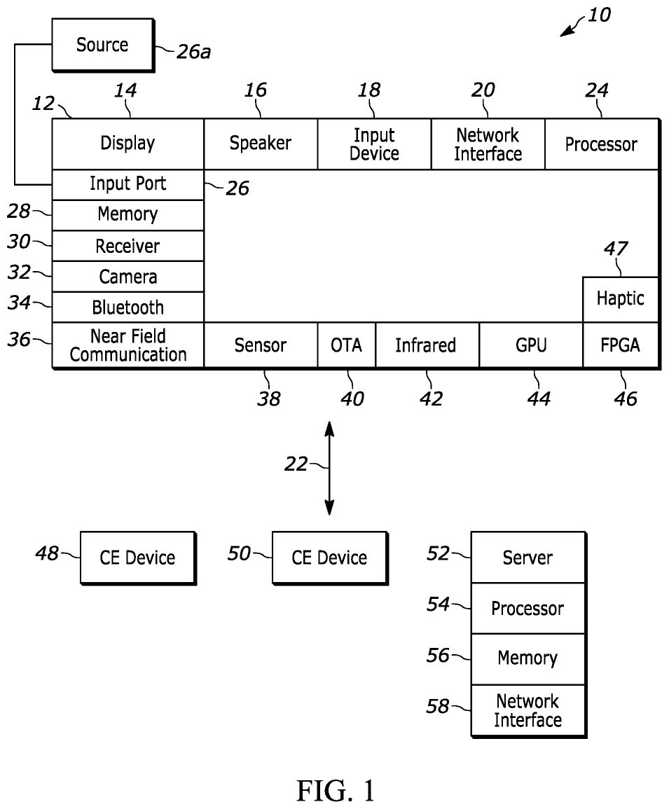

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

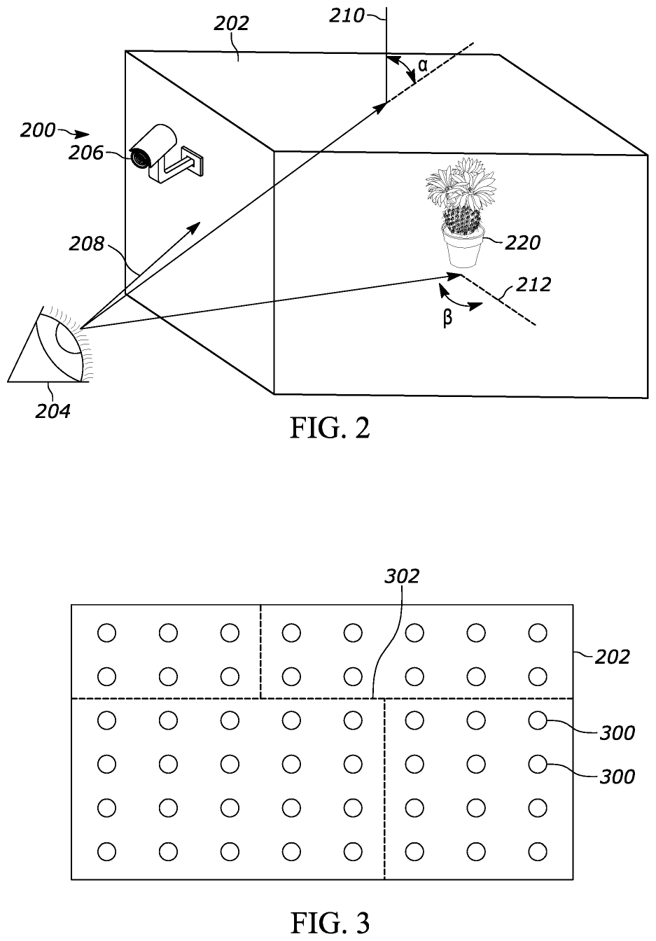

FIG. 2 illustrates at least one flat panel display 202 that may be a standalone display or part of a multi-display assembly 200 that has plural flat panel displays 202. In the example shown, the display assembly is box-shaped, shown in an oblique view in FIG. 2 for illustration purposes, and thus has four side display panels and one top display panel arranged on an open or solid base, to resemble a fish tank. Other configurations are contemplated. The displays/panels 202 may be discrete flat panel displays such as separate liquid crystal displays (LCD) or light emitting diode (LED) displays or projection displays such as disclosed in commonly-owned U.S. Pat. No. 11,520,217, incorporated herein by reference. The display panels 202 may therefore be separately-addressable displays that are electrically and communicatively coupled to each other but are still distinct, each one capable of individually presenting entire images independent of any other panels 202.

The location of a user 204 relative to the assembly 200, and in particular relative to the panel of the assembly closest to the user, may be determined from, e.g., signals from one or more sensors 206 (such as images from one or more cameras or acoustic signals from one or more microphones that may be part of the assembly 200). Then, depending on the angle of view of the user 204 to each display panel 202 (which may include angles of view to each pixel or group of pixels of the respective display panel) as imaged by one or more cameras 206, one or more three-dimensional (3D) virtual images 220 may be varied to each display panel to produce a visualization where the user is able to physically move around at different angles to inspect different areas of the rendered image/overall virtual object (which might appear stationary as the user moves), just as the user might view a real-life object in a real-life fish tank by moving around the real-life object within the tank.

Accordingly, the rendering of the one or more images 220 may be varied for each individual display panel according to the angle of view, which includes varying the images 220 for each individual pixel and/or group of pixels depending on the angle of view to the pixel/group of pixels. For disclosure purposes, the angle of view may be expressed herein relative to the surface normal of each display panel (or pixel or group of pixels). Thus, the angle of view of the user 204 to the closest display panel 202 is directly along the normal 208 of that closest display panel, and hence is zero using the convention of the instant disclosure.

In contrast, the angles of view to the top display panel and right side display panel of the assembly 200 shown in FIG. 2 are oblique to the surface normal of those display panels (and their respective pixels). Thus, the angle of view to the top display panel relative to its normal 210 forms an oblique angle α with the normal 210, whereas the angle of view to the right side display panel relative to its normal 212 forms an oblique angle β with the normal 212 which is greater (using the example convention herein) than the angle of view a to the top display panel.

FIG. 3 illustrates a display panel 202 of the assembly 200 which includes plural pixels 300, which may be divided into groups of pixels as illustrated by the dashed lines 302.

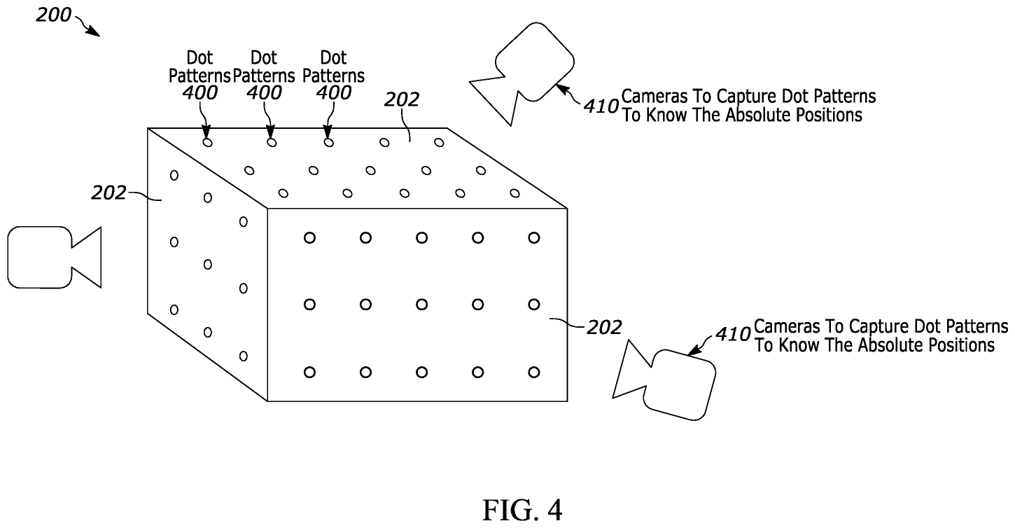

Turning to FIG. 4, it is to be understood that multi-display assemblies having more than one distinct display panel (and even stand-alone, single display panels) may be used in fish tank VR implementations as well as other implementations consistent with present principles. However, it is further recognized herein that each display panel that is used for the fish tank-style display assembly may have relatively small but notable irregularities in terms of flatness, orientation, and display presentation ability. These irregularities might be related to manufacturing and assembly of the panels, for example. But regardless of origin, these irregularities can negatively affect the overall quality of the virtual image that gets presented, leading to a rendering that seems off to the user. This in turn adversely affects the immersiveness of the overall virtual reality (VR) presentation itself.

Indeed, these irregularities can be an issue in other types of displays encompassed by present principles as well, including single flat-panel displays (e.g., televisions), smartphone displays, laptop displays, computer monitors, etc. Techniques and devices set forth below may therefore be used to detect irregularities in any of those types of displays (and still other types) to adjust image rendering accordingly so that the rendered image looks realistic and immersive despite the irregularities by compensating for the irregularities. Thus, it is to be further understood that present principles are not necessarily limited to VR embodiments alone and may apply to other types of presented images as well.

With the foregoing in mind, reference is now made to FIG. 4. The assembly 200 is again shown, with each panel 202 presenting a respective virtual dot pattern 400. The dot patterns 400 may be used to calibrate the distortion of each display panel and also any misalignment amongst the display panels. Accordingly, one or more cameras 410 may be used to gather detailed images/video of the external surfaces of the panels 202 and provide them to the system 10. As such, the cameras 410 may be high-definition 4K digital cameras if desired, though other types of cameras may also be used. Either way, computer vision may then be executed using the images/video from the camera(s) 410 to identify the display irregularities themselves.

The cameras 410 may be mounted or stationary within the same environment as the assembly 200, or an end-user may even take a single camera or multiple cameras 410 and move them about the assembly 200 to direct the field of view (FOV) of the cameras 410 at the assembly 200 from different viewing angles so that all outer surface areas of the panels 202 may be imaged. Using the resulting images, the system 10 may then identify any irregularities on the outer surfaces of the panels 202, including at least those surfaces used for image presentation (e.g., not the bezel or frame of each panel that is not configured for image presentation). The system 10 may also identify panel orientation with respect to other panels 202 using the resulting images.

As for the identified irregularities themselves, they may relate to undulations or other physical yet irregular peaks, valleys, curves, etc. in the supposed flat front surface of the panel 202. Irregularities may also include rendering irregularities such as one or more pixels having an irregular (e.g., non-uniform or unexpected) brightness, contrast, or resolution deficiency.

To this end, a convolutional neural network (NN) or other type of artificial intelligence-based machine learning model may be incorporated into the computer vision software of the system 10 to recognize panel irregularities. The model may be trained on at least one dataset that includes images of different display panels with irregularities as well as respective ground truth/labeled irregularities for that panel/image. The training itself may include supervised, unsupervised, and/or reinforcement learning, among others.

Then after training and during deployment, input in the form of additional/different images of display panels as sourced from the cameras 410 may be provided as input to the model for the model to output an inference of one or more panel irregularities it has detected via computer vision. The presented dot patterns as shown in these images may be helpful in evaluating the panels for surface and rendering irregularities since the dot patterns can make the irregularities more pronounced and therefore easier to detect than, for example, analyzing a deenergized display panel (e.g., powered off).

The cameras 410 may also capture the dot patterns for the system 10 to determine the absolute positions of the panels 202 and/or their orientations with respect to each other, with the dot patterns again being used to make alignment irregularities more pronounced for easier detection by the system 10. Alignment irregularities may relate to oblique X, Y, and/or Z orientation of one panel with respect to an adjacent panel, rather than orthogonal or parallel orientation of the adjacent panels, for example. Pattern recognition, boundary recognition, and other computer vision techniques may therefore be used to detect display misalignment using the dot patterns. The actual angle/orientation of the dots in the known pattern(s) may therefore be used as indicators of one display panel's overall orientation with respect to other panels 202.

Thus, it is to be understood more generally that dot pattern departure from an expected dot pattern layout may be used for detecting not just panel misalignment but also other irregularities, with the system 10 comparing the expected dot pattern layout with the dot pattern appearance that is actually detected. Accordingly, the system 10 may use the dot patterns 400 as shown in the images from the camera(s) 410 to calibrate the position of each panel 202 on the assembly 200, the flatness of each panel, and the brightness, contrast, and/or resolution of each panel. Using the calibration, subsequent virtual image presentation may then be fine-tuned based on the detected irregularities (and possibly also based on one or more user angles of view to the particular panel in fish tank VR embodiments).

What's more, in some examples each independent panel 202 may present an asymmetric dot pattern or other type of different image. This may be done so that irregularities may be detected while each panel 202 is concurrently illuminated with its respective pattern, allowing the system 10 to disambiguate each panel 202 to help determine each panel's absolute position (and/or any potential irregularities) to thus calibrate the distortion of each panel 202 and its potential misalignment for subsequently rendering/projecting additional images without apparent distortion or misalignment from the perspective of the end user.

However, in other examples where symmetric (or still asymmetric) dot patterns or other image types are used, each panel 202 may be time-sequentially illuminated so that one panel 202 is illuminated after another over time until each panel has been imaged (e.g., with no two panels being concurrently illuminated in some specific cases).

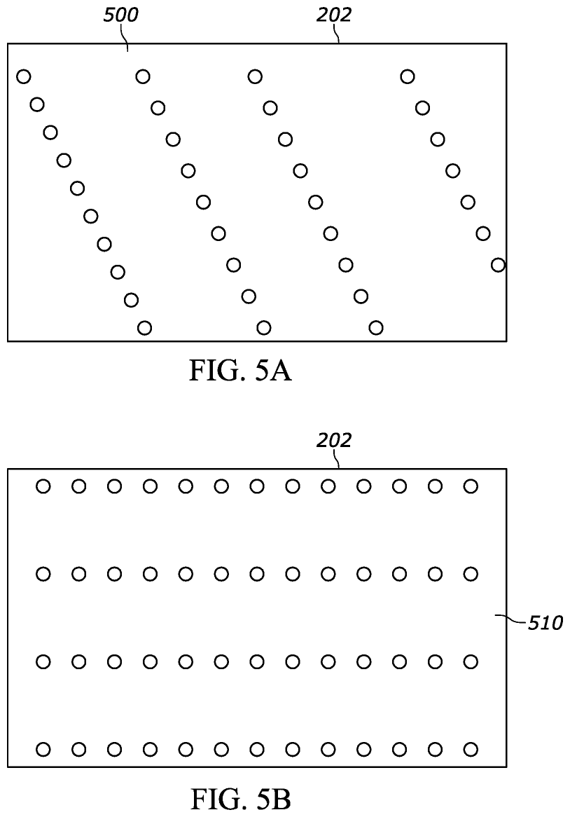

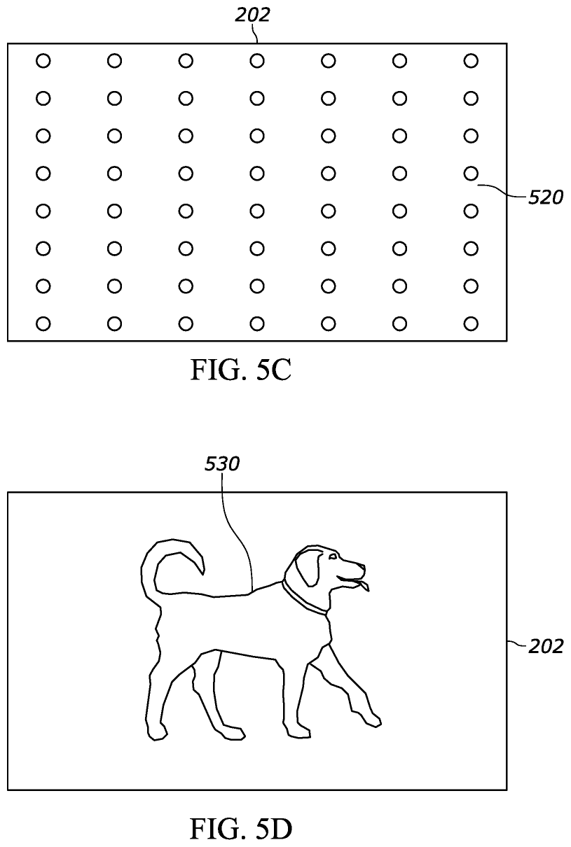

Turning to FIGS. 5A-5D, they show different respective panels 202 presenting different respective dot patterns or other images consistent with present principles. As shown in FIG. 5A, one panel 202 may render a first dot pattern 500 that is established by diagonal rows of dots (diagonal relative to the X and Y axes of the panel 202). FIG. 5B shows that another panel 202 may render a second dot pattern 510 that is established by horizontal rows of dots, while FIG. 5C shows that yet another panel 202 may render a third dot pattern 520 that is established by vertical rows of dots. FIG. 5D then illustrates that other images besides dot patterns (or even patterns more generally) may also be used consistent with present principles, with the panel 202 of FIG. 5D presenting a virtual image 530 of a dog in this example.

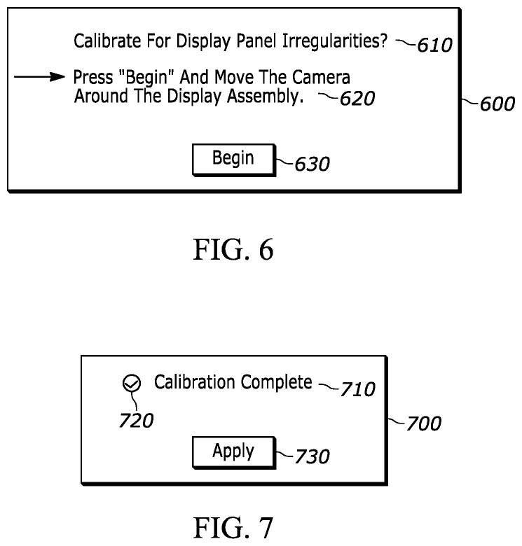

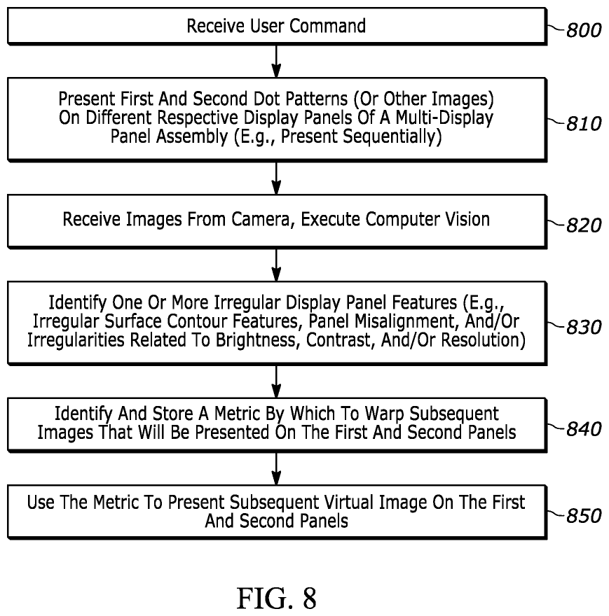

Turning to FIGS. 6 and 7, these figures show example graphical user interfaces (GUIs) that may be presented on the display of a smartphone or other device connected to the cameras 410 (and/or system 10) for determining irregularities in a single panel of single-display assembly or different panels of a multi-display assembly consistent with present principles. Thus, note here that the panels of the assembly need not necessarily be the same fish tank style as the assembly 200. Indeed, present principles may be used for coplanar display panels, curved display panels that together form a spherical or semi-spherical display (or other type of curved display), and/or other multi-display configurations with segmented panels. In any case, the GUIs of FIGS. 6 and 7 may be presented during the calibration process itself.

Accordingly and now in reference to FIG. 6 in particular, the GUI 600 may include a prompt 610 asking the end-user or technician whether the user wishes to calibrate display panels of the overall display assembly (e.g., where the panels may be used together to present a unitary image or fish tank VR simulation). The prompt 610 may also include instructions 620 for the user to select the begin selector 630 to start the process and then move a digital camera (like the camera 410) around the display panels at different angles of view for the camera to capture the surface features and orientations of the panels. The user may then select the begin selector 630 and proceed according to the instructions 620.

Once the computer vision algorithm determines that it has imaged all/enough portions of the outer surface areas of each panel, the GUI 700 of FIG. 7 may be presented to the user in response. The GUI 700 includes a prompt 710 and icon 720 (green check mark in this example) indicating that calibration is complete, signifying that the user may stop moving the camera about the display assembly. Consistent with present principles, the system may then autonomously identify and store a metric by which to warp subsequent images that will be presented on the panels based on any detected panel irregularities. Or in other examples, the system may do so responsive to receipt of a user command as provided via selection of the apply selector 730.

Notwithstanding the foregoing, also note that in addition to or in lieu of a technician or other human taking actions set forth above with respect to FIGS. 6 and 7, the calibration process may be automated more. For example, a static array of cameras situated around the fish tank VR system, and/or one or more cameras on one or more robot arms, may be used to perform an automated calibration process consistent with other aspects mention above.

In such a case, the initial GUI presented to the user (e.g., instead of FIG. 6) may include instructions to “press button to start automated calibration”, with this GUI including an associated “start” button for selection. The subsequent GUI that is presented may then be the same as or similar to the GUI 700 of FIG. 7 itself.

Referring now to FIG. 8, it shows example logic that may be executed by a system such as the system 10, assembly 200, a smartphone, an augmented reality (AR) or VR HMD, a server, and/or any combination thereof consistent with present principles. Note that while the logic of FIG. 8 is shown in flow chart format, other suitable logic may also be used.

Beginning at block 800, the system may receive a user command to begin calibration. For example, at block 800 the system might identify selection of the selector 630 discussed above. From block 800 the logic may then proceed to block 810.

At block 810 the system may present first and second dot patterns (and/or other images) on different respective display panels of a multi-display panel assembly. Or the system may present one or more images on a single panel in a single-display assembly. The image(s) may result in illumination of every pixel of each panel, or only illumination of a subset of pixels (e.g., equally-spaced) from which panel irregularities can still be determined. Again note that the different patterns may be concurrently presented on each panel at the same time, or the patterns may be sequentially presented at different adjacent and/or consecutive times. From block 810 the logic may then proceed to block 820.

At block 820 the system may receive one or more images from a camera, with the images showing the first and second dot patterns. Also at block 820, the system may execute computer vision consistent with the disclosure above to, at block 830, identify one or more irregular display panel features related to the first display panel and/or the second display panel based on the images from the camera. Again note that the irregularities may relate to irregular surface contours/features, panel misalignment, and/or irregularities related to brightness, contrast, and/or resolution. And as mentioned above, the system might not simply look for display irregularities using the camera-sourced images in isolation, but by comparing the camera-sourced images against the expected image layout already known to the system in some specific examples. From block 830 the logic may then proceed to block 840.

At block 840, the system may identify and store one or more metrics by which to warp subsequent images (e.g., in real time) that will be presented on the first and second panels, with the metric(s) being determined based on the one or more irregular display panel features that were identified at block 830. So, for example, in the case of brightness, contrast, and/or resolution, the metrics might be plus/minus pixel value offsets (or even an image filter) that compensate per-pixel or per-pixel-group for display panel pixels with brightness, contrast, or resolution deficiencies of an identified amount (or possibly brightness or contrast surplus of an identified amount). This may be done so that brightness, contrast, and/or resolution of those pixels is normalized and/or matches relative to surrounding pixels, and/or so that the image presentation is normalized according to the intended pixel output values for each respective portion of the rendered image itself (so that actual pixel values even for irregular pixels match the respective intended pixel values).

As another example, pixel value offsets may be determined at block 840, or even an image filter created, to warp a base image (e.g., as provided by a graphics processing unit) prior to scanout to compensate for optical distortions in certain parts of certain panels caused by non-flat panel surface areas or other irregular panel contours. Digital image processing may be used to do so, and in some particular instances pixel-wise mean or median filtering might even be used. Offsets may also be created, and/or another filter created or the same one modified, to warp subsequent images based on panel misalignment as well to avoid situations where a disjointed image is presented owing to display misalignment relative to the logical display arrangement being used by the system. In another example, the metrics gathered and the image warping process may include additional metrics and correction respectively for any perceivable chromatic aberrations/dispersions, wherein the red, green, and blue pixels of the images displayed on one or more panels 202 appear very slightly misaligned, resulting in color fringing (i.e., a blue fringe or a red fringe).

Still in reference to FIG. 8, from block 840 the logic may then proceed to block 850. At block 850 the system may use the metric(s) in real time to present subsequent virtual images (e.g., VR/3D images) on the first and second panels.

Again note for completeness that while the techniques above may be used for multi-panel display assemblies, the techniques may also be used for single-panel/single-display implementations as well.

Moving on from FIG. 8, note more generally that asymmetric dot patterns or other images may be used for the system to disambiguate between display panels and sub-areas (e.g., when each panel is concurrently lit up with the others). Non-uniform (but still known) dot pattern spacing might also be used to further aid in disambiguation. Or the patterns may be uniform over each panel, even if not uniform across different panels. The panels may additionally or alternatively be illuminated sequentially, and in such cases symmetric patterns/images may be used as disambiguation can be performed based on time, with the system already knowing which panel is being illuminated at which time and hence which surface irregularities for which panel are being identified. However, further note that asymmetric patterns may also be used sequentially by the system to more accurately identify panel orientation with respect to other panels, if desired.

Accordingly, images may be pre-warped in real time consistent with present principles to normalize for display panel irregularities and to correct any latent errors in image rendering due to the physical irregularities and disparities amongst the panels themselves. Surface contour-compensating warping may therefore be performed, as well as image alteration/filtering for the pose, position, and orientation of the display panels with respect to each other.

While particular techniques are herein shown and described in detail, it is to be understood that the subject matter which is encompassed by the present application is limited only by the claims.

What is claimed is:

1. An apparatus comprising:
at least one processor assembly configured to:
present first and second dot patterns on different respective display panels of a multi-display panel assembly;
receive one or more images from a camera, the one or more images showing the first and second dot patterns;
based on the one or more images from the camera, identify one or more irregular display panel features related to the first display panel and/or the second display panel; and
based on the one or more irregular display panel features, identify and store a metric by which to warp subsequent images that will be presented on the first and second panels.

2. The apparatus of claim 1, wherein the at least one processor assembly is configured to:
use the metric to present a first image on the first and second panels.

3. The apparatus of claim 1, wherein the first and second dot patterns are different from each other.

4. The apparatus of claim 1, wherein the first and second dot patterns are presented sequentially, the first dot pattern presented before the second dot pattern.

5. The apparatus of claim 1, wherein the one or more irregular display panel features relate to one or more surface contour features of the first display panel and/or the second display panel.

6. The apparatus of claim 1, wherein the one or more irregular display panel features relate to misalignment of the first display panel with the second display panel.

7. The apparatus of claim 1, wherein the one or more irregular display panel features relate to brightness of the first display panel and/or the second display panel.

8. The apparatus of claim 1, wherein the one or more irregular display panel features relate to contrast of the first display panel and/or the second display panel.

9. The apparatus of claim 1, wherein the one or more irregular display panel features relate to resolution of the first display panel and/or the second display panel.

10. The apparatus of claim 1, wherein the one or more irregular display panel features relate to chromatic dispersion of red, green, and/or blue pixels of a first image presented on at least one of the first and second display panels.

11. An apparatus comprising:
at least one computer medium that is not a transitory signal and that comprises instructions executable by at least one processor assembly to:
present first and second patterns on different portions of a display assembly;
receive one or more images from a camera, the one or more images showing the first and second patterns;
based on the one or more images from the camera, identify one or more display panel features related to the display assembly; and
based on the one or more display panel features, identify and store a metric by which to alter presentation of subsequent images that will be presented on the display assembly.

12. The apparatus of claim 1, wherein the instructions are executable to:
use the metric to present a first image on the display assembly.

13. The apparatus of claim 1, wherein the first and second patterns are dot patterns.

14. The apparatus of claim 1, wherein the display panel features comprise irregular display panel features.

15. The apparatus of claim 14, wherein the irregular display panel features comprise one or more irregular surface contour features of the display assembly.

16. The apparatus of claim 14, wherein the irregular display panel features comprise misalignment of a first display panel on the display assembly with respect to a second display panel on the display assembly.

17. The apparatus of claim 14, wherein the irregular display panel features comprise one or more of: irregular brightness of the display assembly, irregular contrast of the display assembly, irregular resolution of the display assembly.

18. A method, comprising:
presenting at least a first image on a display assembly;
receiving one or more second images from a camera, the one or more second images showing the first image;
based on the one or more second images from the camera, identifying one or more display panel features related to the display assembly; and
rendering a subsequent image on the display assembly according to a metric by which to alter presentation of the subsequent image, the metric determined based on the one or more display panel features.

19. The method of claim 18, comprising:
presenting the first image and a third image to identify the one or more display panel features.

20. The method of claim 19, wherein the first and third images comprise respective patterns that are asymmetric from each other.
